(19) United States
(12) Patent Application Publication
(10) Pub. No.: US 2004/0188010 A1
(43) Pub. Date: Sep. 30, 2004

(54) Continuous lamination of RFID bands and inlets

(76) Inventor: Sam M. Chaoui, Diamond Bar, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/396,586

(22) Filed: Mar. 24, 2003

(51) Int. Cl. B32B 31/18

(52) U.S. Cl. 156/269; 156/277

(57) ABSTRACT

A process for continuous lamination of radio frequency identification (RFID) bracelets includes placing at least one RFID inlet between two substrates made of plastic sheets or rolls of web. A continuous source of pre-fabricated RFID inlets is provided which can include target marks at specific locations for timing and indexing purposes. The RFID inlets are dispensed and then sealed between the substrates. This forms a continuous strip which is then separated into a plurality of separate bracelets of predetermined length and shape. Separation of the continuous strip into a plurality of separate bracelets may be accomplished by die-cutting the continuous strip. Alternatively, instead of dispensing individual RFID inlets between two substrates, a substrate containing RFID inlets may be sealed between the two substrates.

### BACKGROUND OF THE INVENTION

This invention relates to identification bracelets or bands which are widely used in a variety of applications. More particularly, the present invention relates to bracelets or bands with radio frequency identification (RFID) inlets.

Identification bracelets are commonly utilized in crowd control contexts such as amusement parks, ski lifts, and rock concerts. They are applied to the wrists of the persons visiting the amusement park, utilizing the ski lift, or attending the concert in order to identify the customer and prevent various abuses which arise where large numbers of individuals congregate.

Identification bracelets have also been used in hospital or medical clinics. Initially, such wristbands were confined to providing the bare minimum of the patient's name and, possibly, of the patient's illness. In crowd control situations, the wristband was utilized to indicate the admissibility of the individual wearing the band and, frequently, the duration, by color indication, of the attendance period of the person wearing the wristband. For instance, the bracelet for a concert can incorporate visually perceptible information regarding seat assignments; for amusement parks, the number of rides to which the individual is entitled; and, for ski lifts, the numbers of lifts and the numbers of rides to which the individual is entitled

Various types of prior art bracelets have been utilized in the above-mentioned situations, including bracelets fabricated from plastic sheet materials such as vinyl and various forms of plastic reinforced papers wherein the cellulosic content of the papers is bonded and strengthened by the plastic binder.

Some prior art bracelets include electronic information receptor means, such as magnetic strips or the like, and the information is imparted to the magnetic strip by corresponding electronic information conveyors. Additional or alternative information regarding the extension of credit or spending limit available to an individual may be incorporated in the information imparted to the bracelet. Other bracelets incorporate bar coding as a method of conveying information regarding the individual and the extent of his purchases. A bar code reader may be used to ‘read’ the bracelet and pull up information regarding the wearer of the bracelet from a main database containing information about the wearer of the bracelet such as name, room number, duration of stay, extension of credit or spending limit available.

RFID circuitry has been incorporated into wristbands. For example, Mosher, Jr., U.S. Pat. No. 5,973,600, the contents of which are hereby incorporated herein, teaches a wristband that incorporates RFID identification circuitry. However, the process described requires that the RFID circuitry be created during the process of making the RFID wristband.

Accordingly, while methods such as those described above may provide means of manufacturing RFID bracelets, such methods can always be improved. One of the drawbacks to creating the RFID circuitry during the process of making an RFID wristband is that errors, such as misalignment, in laying down the circuitry on the bracelet can slow or even halt production. If the circuitry equipment is misaligned such that the circuitry is not properly overlayed on the bracelet, the production line must be shut down until the error is corrected. There is a need for an RFID bracelet manufacturing process that minimizes the chance that any one part of the manufacturing process will slow down overall production.

Accordingly, there is a need for an even more efficient and cost-effective method of making RFID wristbands. The present invention fulfills these needs and provides other related advantages.

### SUMMARY OF THE INVENTION

The present invention resides in a process for continuous lamination of RFIDs wristbands. The manufacture of RFID bracelets from continuous rolls of spaced apart pre-fabricated RFID inlets (i.e., chip and antenna) provides an efficient and cost-effective method of making RFID bracelets.

The process for continuous lamination of radio frequency identification (RFID) bracelets includes a continuous lamination process of placing at least one RFID inlet between two substrates (i.e., a top substrate and a bottom substrate) made of plastic sheets or rolls of web. A continuous source of RFID inlets is provided. This continuous source of RFID inlets can include target marks at specific locations for timing and indexing purposes.

The RFID inlets are dispensed and then sealed between the top and bottom substrates. This forms a continuous strip which is then separated into a plurality of separate bracelets of predetermined length and shape. Separation of the continuous strip into a plurality of separate bracelets may be accomplished by die-cutting the continuous strip. Dispensing the RFID inlets between the two substrates may require that the roll of RFID inlets be indexed. If the RFID inlets become unregistered with respect to the top and bottom substrates during the process, registration of the RFID inlets with respect to the substrates can be corrected.

Indicia may be printed upon a surface of one or more bracelets. Information may be electronically imparted to the RFID inlet of one or more bracelets during the process or at a later time.

The RFID inlets may be dispensed sequentially or one or more pairs of the RFID inlets may be dispensed in parallel. At least one RFID inlet may be die-cut and placed on a top surface of the bottom substrate. In an alternative, the RFID inlets may also be spaced apart based on the predetermined length and shape of the bracelets.

The process may further include placing the RFID inlets on the bottom substrate, indexing the source of RFID inlets, and then forming each RFID inlet for placement on the bottom substrate.

The RFID inlets may be sealed between the two substrates by heat sealing the RFID inlets between the top and bottom substrates. Alternatively, an adhesive coating may be placed on at least one of the top and bottom substrates. RFID inlets can then be positioned on the adhesive coating, and then sealed between the two substrates.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a schematic view illustrating the process of laminating RFID bracelets in accordance with one embodiment of the present invention;

FIG. 2 illustrates a continuation of the process of FIG. 1;

FIG. 3 illustrates an alternative embodiment of the process of laminating RFID bracelets;

FIG. 4. illustrates a continuation of the process of FIG. 3;

FIG. 5 illustrates a web substrate with regions of small slits;

FIG. 6 is a cross-sectional view of a strip formed by an RFID substrate and a bottom substrate; and

FIGS. 7 and 8 illustrate, respectively, top plan and cross-sectional views of an RFID label produced by the processes of FIGS. 1 and 3, wherein the cross-section is taken along line 8-8 of FIG. 7.

### DETAILED DESCRIPTION OF THE PREFERRED EMBODIMENTS

The present invention resides in a process for continuous lamination of RFIDs wristbands. The manufacture of RFID bracelets from continuous rolls of spaced apart pre-fabricated RFID inlets provides an efficient and cost-effective method of making RFID bracelets. The process for continuous lamination of radio frequency identification (RFID) bracelets includes a continuous lamination process of placing at least one RFID inlet between two substrates (i.e., a top substrate and a bottom substrate) made of plastic sheets or rolls of web. A continuous source of pre-fabricated RFID inlets is provided and reduces and/or eliminates the drawbacks associated with creating the RFID circuitry during the process of making the RFID wristband. Therefore, the chances are minimized that the overall production will be slowed down due to errors in RFID circuitry.

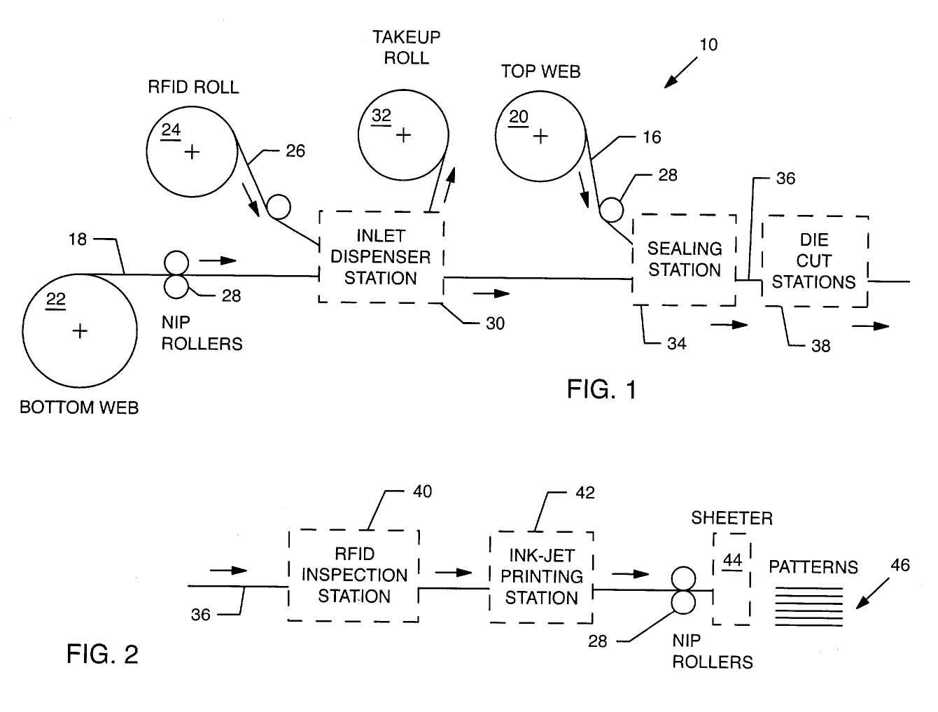

As illustrated in FIGS. 1, 2 and 5, a continuous lamination apparatus 10 incorporates a process that manufactures RFID bracelets 12 by placing at least one RFID inlet 14 between two layers or substrates (i.e., a top substrate 16 and a bottom substrate 18). The RFID inlet 14 may be of a read only, read/write, a passive, or an active configuration. The substrates 16, 18 may be made of an engineering thermoformed plastic in the form of respective sheets or rolls 20, 22 of web material that may include polyester, a low-density polyethylene and the like. This process sandwiches the RFID inlet(s) 14 between the top and bottom substrates 16, 18 of web material. In the alternative, magnetic strips may be used in place of, or in conjunction with, RFID inlets 14. The RFID inlets 14 are pre-fabricated in a roll form 24 on a substrate 26 from which the RFID inlets 14 can be separated.

The RFID inlets 14 and substrates 16, 18 are shown following a generally lineal path through the apparatus 10. In the interests of space economy, a more circuitous path can be followed as required by geometry and placement of the elements of the apparatus 10.

Juxtaposed to the lineal path of the RFID inlets 14 and substrates 16, 18 is a translating means (not shown). The translating means includes a number of nip or drive rollers 28 positioned along the apparatus 10 in order to move the RFID inlets 14 and substrates 16,18 along from station to station. These drive rollers 28 frictionally engage with the surfaces of the RFID inlet substrate 26, as well as the top and bottom substrates 16, 18, frictionally driving the substrates 16,18, 26 through the apparatus 10.

The drive roller 28 can be rotated by an electric motor or similar means, but it is preferable that a stepper motor or the like be utilized in the apparatus 10 because the process of the invention may require that the RFID inlets 14 and substrates 16,18 be halted intermittently for purposes to be discussed in greater detail below.

The speed of the stepper motor can be regulated by suitable control means (not shown) in order to control the translation of the RFID inlets 14 and substrates 16, 18 through the apparatus 10 and control the length of the dwell times necessitated by the process of the invention.

The process begins with the pre-fabricated roll of RFID inlet(s) 24. The roll width could have single or multiple RFID inlets 14 placed either side-by-side or sequentially one-after-the-other. However, it is preferable that the RFID inlets 14 be spaced apart depending on the desired length and width of the bracelets 12. The length of roll 24 is then supplied as needed. Target marks (not shown) may be placed at specific locations and incorporated on the roll 24 of RFID substrate 26 for timing and indexing purposes later in the manufacturing process. Alternatively, the RFID inlets 14 and substrate web materials can be provided in fan-folded or other configurations and dispensed from a suitable receptacle.

An inlet dispenser station 30 accommodates the substrate 26 holding the RFID inlets 14 and bottom substrate 18. The inlet dispenser station 30 indexes the RFID inlet substrate 24, die-cuts an RFID inlet 14, removes the RFID inlet 14 from the substrate 26 and places the RFID inlet 14 on a top surface of the bottom substrate 18. A takeup roll 32 is used to collect the substrate 26 from which the RFID inlets 14 have been removed. The bottom substrate 18, now including the RFID inlets 14, is then moved into a sealing station 34. The top substrate 16 is also moved into the sealing station 34. The top and bottom substrates 16,18 may then be laminated or sealed together as one continuous substrate 36, either through a heat-sealing process using a heated die or by using an adhesive coating. The top and bottom substrates 16, 18 may be transparent, translucent, colored in solid colors or multi-color decorative patterns. For example, both top and bottom substrates 16, 18 may be blue in color. In another example, one of the substrates 16, 18 could be blue while the other substrate could be red. In yet another example, the substrates may be covered with holiday patterns (e.g., Christmas, Chanukah, Fourth of July, Halloween, etc.). Alternatively, the RFID inlets 14 may be loose and either hand or machine positioned on the bottom substrate 18.

In order to improve registration of the RFID inlets 14 with respect to the top and bottom substrates 16, 18, the take-up roller 32 may, temporarily, hold onto an unregistered RFID inlets 14 web until the registration is corrected by an electronic feedback loop. At this time, the apparatus 10 will correlate the target marks on the RFID substrate 26 with the top and bottom substrates 16, 18. Once the substrates 16, 18, 26 are again coordinated with each other, the process may resume.

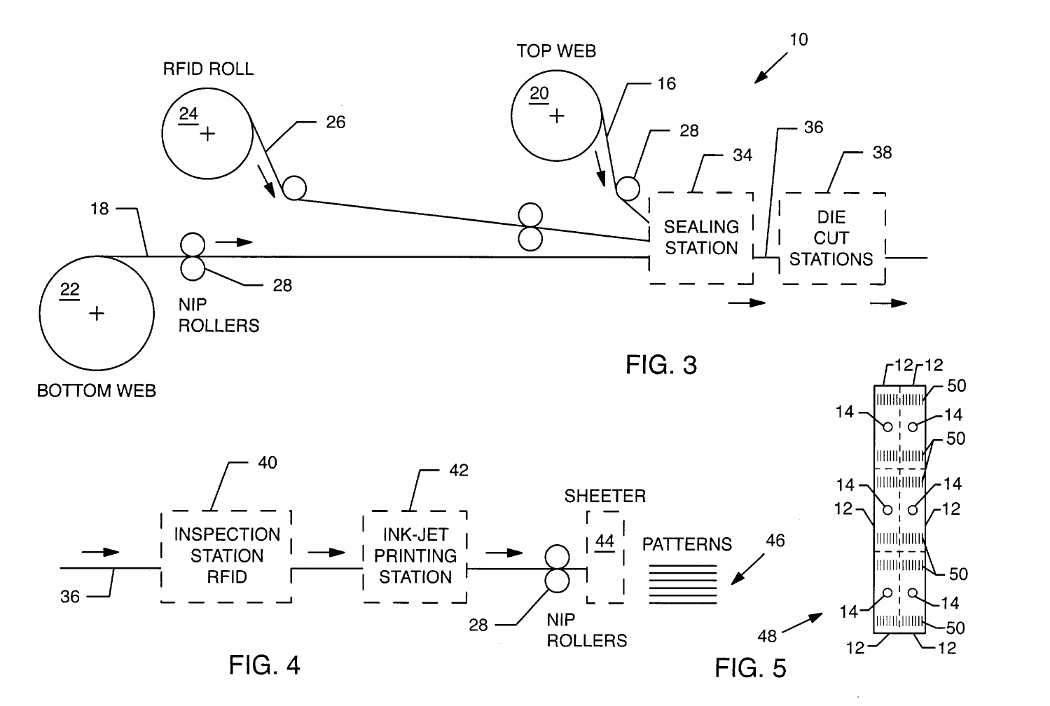

As illustrated in FIGS. 3, 4 and 5, a continuous lamination apparatus 10 incorporates an alternative process that manufactures RFID bracelets 12 by eliminating the dispenser station 30 and laminating or sealing together all three substrates (i.e., RFID inlet substrate 26, top substrate 16, bottom substrate 18) as one continuous substrate 36, either through a heat-sealing process using a heated die or by using an adhesive coating.

As outlined above, the RFID inlets 14 on the RFID inlet substrate 26 are pre-fabricated and may be of a read only, read/write, a passive, or an active configuration. The substrates 16,18,26 may be made of the same materials as described above. This process sandwiches the RFID substrate 26 between the top and bottom substrates 16, 18 of web material. In the alternative, a continuous substrate that includes a plurality of magnetic strips may be used in place of RFID inlets 14. In yet another alternative, a continuous substrate that includes a plurality of magnetic strips paired with a matching plurality of RFID inlets 14 may also be used in place of RFID inlets 14 alone. As all three substrates 16, 18, 26 are laminated together, the apparatus 10 uses electronic feedback to continuously coordinate the target marks (not shown) on all three substrates 16,18, 26 for timing and indexing purposes.

Regardless of which process is used (i.e., the process shown in FIGS. 1 and 2 or the process shown in FIGS. 3 and 4), after lamination, the single substrate 36 will then be moved into die-cut stations 38 where the continuous substrate 36 will be die-cut to the shape and form of the bracelets 12 in a sheet or pattern configuration.

The bracelets 12, still held together on the substrate 36, are then moved into an RFID inspection station 40. The functionality and location of the RFID inlets 14 on the bracelet 12 are determined by the RFID inspection station 40 and compared with pre-determined criteria to determine if the RFID inlets 14 are positioned within tolerances of a predetermined position on the bracelet 12. Bracelets 12 with non-functional or badly positioned RFID inlets 14 are marked and separated from bracelets 12 with functional and correctly positioned RFID inlets 14 later in the process.

The bracelets 12 then move into an ink-jet printing station 42 where indicia may be printed upon a surface of one or more bracelets 12. Information may also be electronically imparted to the RFID inlets 14 of one or more bracelets 12. Where prior art expedients are utilized, this entails the utilization of a suitable printer or other information imprinting device into which the bracelet 12 is introduced and the requisite information regarding a user, corporation, person or object is to be applied to a surface of the bracelet 12, or imparted into the aforesaid magnetic strip and/or RFID chip. Decorative, as well as informative, indicia may also be printed on the bracelets 12.

From there, the bracelets 12 move to a sheeter 44 for cutting and stacking sheets of bracelets 12. The bracelets 12 are cut and sized into sheets, according to predetermined patterns 46 of various sizes and shapes. The patterns 46 of bracelet sheets are then stacked one atop each other at the end of the process.

Registration of the substrates 16, 18, 26 may also be assisted via the use of a specially designed web substrate 48 with regions of small slits 50 across its width, as seen in FIG. 5. When registration of the substrates 16, 18, 26 is offset, the slits 50 allow the substrate material to be stretched in order to compensate for the offset registration. The slits of each region 50 may be placed in any orientation on the substrate 48.

By using a continuous source of pre-fabricated RFID inlets, the fabrication process is improved and inefficiencies during the manufacturing process reduced and/or eliminated. The use of pre-fabricated substrates alone allows replacement rolls of substrate to quickly be placed on the apparatus 10 once the old roll of substrate has been used up; allowing production to quickly resume once the replacement roll is in position. The use of a pre-fabricated RFID substrate 26 also minimizes the chances that overall production will slowed down due to errors in RFID circuitry as pre-fabricated rolls 24 of RFID substrate 26 may have already been inspected to ensure that the RFID inlets 14 are functioning properly.

In certain situations, it may be desirable to use only the RFID chip and not the antenna. In these situations, when the RFID inlets 14 are cut and positioned on the bottom substrate 18, the antenna material of the RFID inlet 14 may be etched away, leaving only the RFID chip.

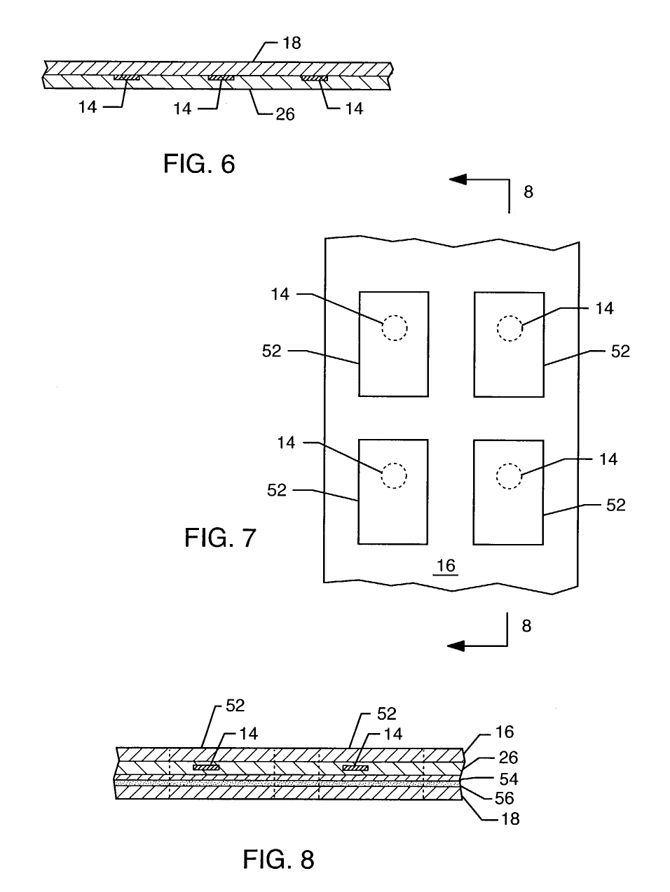

In another alternative, in order to reduce materials and cost, the top substrate 16 may be eliminated and the RFID substrate 26 used in its place as the top substrate, as seen in FIG. 6. The RFID inlets 14 would then be sandwiched between the RFID substrate 16 and the bottom substrate 18. This would ensure a secure lamination and a thinner, more flexible band. Additionally, the RFID antenna could be printed on the bottom web 18, if the RFID substrate 26 includes only RFID chips. In a further alternative, if only the top and bottom substrates 16, 18 are used, the RFID chip circuitry could be printed concurrently with the printing of the antenna, as outlined above. Organic circuits could be used when printing the RFID chip circuitry.

In an additional alternative, the above-described process could be used to produce labels 52 instead of bracelets, as shown in FIGS. 7 and 8. In this alternative, a substrate 26 of RFID inlets could be sandwiched between a top substrate 16 and a bottom substrate 18. In this situation, these substrates may be made of paper, writable plastic or the like. The bottom of RFID substrate 26 would be at least partially covered by a layer of adhesive 54 while a top surface of the bottom substrate 18 would be at least partially covered by a silicone release layer 56 in the area of, around, and near the labels 52. The substrates 16,26, 18 are laminated together and die-cut into labels.

Consequently, by the practice of the processes described above, many of the problems inherent in present day identification bracelet supply are eliminated, with consequent economies in the supply of the bracelets resulting from the processes described above and the elimination of unnecessary expenditures of time and energy incident to the utilization of conventional identification bracelets.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

What is claimed is:

1. A process for continuous lamination of radio frequency identification (RFID) bracelets, comprising the steps of:
providing a continuous source of RFID inlets;
dispensing the RFID inlets between top and bottom substrates of web material;
sealing the RFID inlets between the top and bottom substrates to form a continuous strip; and
separating the continuous strip into a plurality of separate bracelets of predetermined length and shape.

2. The process of claim 1, further comprising the step of printing indicia upon a surface of one or more bracelets.

3. The process of claim 1, further comprising the step of applying electronically imparted information to the RFID inlet of one or more bracelets.

4. The process of claim 1, wherein a plurality of the RFID inlets are dispensed sequentially.

5. The process of claim 4, wherein the RFID inlets are spaced apart based on the predetermined length and shape of the bracelets.

6. The process of claim 4, wherein at least a pair of the RFID inlets are dispensed in parallel.

7. The process of claim 1, further including the steps of placing the RFID inlets on the bottom substrate, indexing the source of RFID inlets, and forming each RFID inlet for placement on the bottom substrate.

8. The process of claim 1, wherein the sealing step includes the step of heat sealing the RFID inlets between the top and bottom substrate web materials.

9. The process of claim 1, wherein the sealing step includes the step of placing an adhesive coating on at least one of the top and bottom substrates, and placing the RFID inlets on the adhesive coating.

10. The process of claim 1, wherein the separating step includes the step of die-cutting the continuous strip.

11. The process of claim 1, further including the step of correcting registration of the RFID inlets with respect to the top and bottom substrates.

12. The process of claim 11, wherein the continuous source of RFID inlets includes target marks at specific locations for timing and indexing purposes.

13. The process of claim 1, wherein the dispensing step further includes the step of indexing the continuous source of RFID inlets, die-cutting at least one RFID inlet, and placing at least one RFID inlet on a top surface of the bottom substrate.

14. A process for continuous lamination of radio frequency identification (RFID) bracelets, comprising the steps of:
providing a continuous source of RFID inlets in roll form;
dispensing a plurality of RFID inlets sequentially between top and bottom substrates of web material;
heat sealing the RFID inlets between the top and bottom substrates to form a continuous strip;
separating the continuous strip into a plurality of separate bracelets of predetermined length and shape; and
printing indicia upon a surface of each bracelet.

15. The process of claim 14, wherein the substrates are in the form of sheets or rolls of web material.

16. The process of claim 14, wherein the RFID inlets are spaced apart based on the predetermined length and shape of the bracelets.

17. The process of claim 14, further including the steps of placing the RFID inlets on the bottom substrate, indexing the source of RFID inlets, and forming each RFID inlet for placement on the bottom substrate.

18. The process of claim 14, wherein the sealing step further includes the step of placing an adhesive coating on at least one of the top and bottom substrates, and placing the RFID inlets on the adhesive coating.

19. The process of claim 14 wherein the step of separating the continuous strip into a plurality of separate bracelets of predetermined length and shape includes the step of die-cutting the continuous strip.

20. A process for continuous lamination of radio frequency identification (RFID) bracelets, comprising the steps of:
providing a continuous source of RFID inlets in roll form;
dispensing the RFID inlets between top and bottom substrates of web material;
placing an adhesive coating on at least one of the top and bottom substrates;
positioning the RFID inlets on the adhesive coating.
heat sealing the RFID inlets between the top and bottom substrate web materials to form a continuous strip;
die-cutting the continuous strip into a plurality of separate bracelets of predetermined length and shape; and
printing indicia upon a surface of each bracelet;
wherein the RFID inlets on the roll of RFID inlets are spaced apart based on the predetermined length and shape of the bracelets.

21. A process for continuous lamination of radio frequency identification (RFID) bracelets, comprising the steps of:
providing a continuous substrate including a plurality of RFID inlets;
sealing the continuous substrate and a bottom substrate together to form a continuous strip; and
separating the continuous strip into a plurality of separate bracelets of predetermined length and shape.

22. The process of claim 21, further comprising the step of printing indicia upon a surface of one or more bracelets.

23. The process of claim 21, further comprising the step of applying electronically imparted information to the RFID inlet of one or more bracelets.

24. The process of claim 21, wherein the RFID inlets are spaced apart on the continuous substrate based on the predetermined length and shape of the bracelets.

25. The process of claim 21, wherein the sealing step includes the step of heat sealing the continuous substrate and bottom substrate together.

26. The process of claim 21, wherein the sealing step includes the step of placing an adhesive coating on the bottom substrate, and placing the continuous substrate of RFID inlets on the adhesive coating.

27. The process of claim 21, wherein the continuous substrate of RFID inlets includes target marks at specific locations for timing and indexing purposes.

28. A process for continuous lamination of radio frequency identification (RFID) labels, comprising the steps of:
providing a continuous source of RFID inlets;
dispensing the RFID inlets between top and bottom substrates;
sealing the RFID inlets between the top and bottom substrates to form a continuous strip; and
separating the continuous strip into a plurality of separate labels of predetermined length and shape.

29. The process of claim 28, further comprising the step of applying electronically imparted information to the RFID inlet of one or more labels.

30. The process of claim 28, wherein the RFID inlets are spaced apart on the continuous source based on the predetermined length and shape of the labels.
